(19) United States
(12) Patent Application Publication
(10) Pub. No.: US 2025/0348406 A1
(43) Pub. Date: Nov. 13, 2025

(54) METHOD FOR TESTING DEVICE SOFTWARE OF A DEVICE BY MEANS OF A FUZZING ALGORITHM

(71) Applicant: Robert Bosch GmbH, Stuttgart (DE)

(72) Inventors: Janos Kepics, Debrecen (HU); Mera Saulaiman, Budapest (HU); Akos Csilling, Budapest (HU)

(21) Appl. No.: 18/662,157

(22) Filed: May 13, 2024

(51) Int. Cl. G06F 11/36

(52) U.S. Cl. CPC G06F 11/3608

(57) ABSTRACT

A method for testing device software of a device using a fuzzing algorithm. The method includes: initializing the fuzzing algorithm to detect an initial behavior of the device software of the device under test; executing a fuzzing test loop including: generating a fuzzed message from predefined message types; sending the generated, fuzzed message to the device under test to test the device software on the basis of the fuzzed message; detecting side-channel information during testing of the device software on the basis of the fuzzed message; recognizing anomalies in the side-channel information using at least one machine learning model and/or statistical algorithm; and if an anomaly is recognized, adjusting a parameter including adjusting fuzzability weights, of the initialized fuzzing algorithm and performing a next loop iteration of the fuzzing test loop; and if no anomaly is recognized, performing the next loop iteration of the fuzzing test loop.

### FIELD

The present invention relates to a method for testing device software of a device by means of a fuzzing algorithm. The present invention also relates to an apparatus for testing device software of a device by means of a fuzzing algorithm.

### BACKGROUND INFORMATION

The security and reliability of applications is important in software development. Fuzz tests, a method of automated software testing, are of interest when it comes to ensuring the robustness of software against unpredictable and/or faulty inputs. While fuzzing in a white-box environment, where there is full access to the source code, enables a targeted and efficient strategy, the practical limitations of commercial fuzzing tools raise questions about their transparency and adjustability. These tools, including conventional tools such as AFL (American fuzzy lop), use feedback mechanisms for source code coverage to increase effectiveness, but do not reveal the details of their internal workings.

Another critical aspect is the challenge of testing products with integrated software and hardware without direct access to the source code. In such black-box environments, fuzzing remains largely a kind of “game of chance” due to the lack of feedback on the source code. This approach harbors the risk that certain code paths and potential vulnerabilities remain untouched during the testing process.

The core problem posed by this methodology is the limited effectiveness of black-box fuzzing, since it does not allow the identification of specific vulnerable areas in the code. This limitation leads to the fact that potential errors can go undetected, since without detailed feedback on code execution, certain instructions may never be tested. Thus, the current practice of fuzzing reveals a critical gap in the ability to comprehensively check software for vulnerabilities.

These challenges and disadvantages highlight the need to rethink and improve existing fuzzing methods.

It is an object of the present invention to provide an improved method and/or an apparatus in this respect.

The object may be achieved by a method in accordance with features of the present invention. The object may also be achieved by an apparatus in accordance with features of the present invention.

### SUMMARY

According to a first aspect of the present invention, a method for testing device software of a device by means of a fuzzing algorithm is provided. According to an example embodiment of the present invention, the method includes the steps of:
initializing the fuzzing algorithm to detect an initial behavior of the device software of the device under test,
executing a fuzzing test loop, in particular until a termination criterion is reached, wherein the fuzzing test loop comprises the steps of:
generating a fuzzed message from predefined message types;
sending the generated, fuzzed message to the device under test to test the device software on the basis of the fuzzed message; detecting side-channel information during testing of the device software on the basis of the fuzzed message;
recognizing anomalies in the detected side-channel information by means of at least one machine learning model and/or statistical algorithm; and
if an anomaly is recognized, adjusting a parameter, in particular adjusting fuzzability weights, of the initialized fuzzing algorithm and performing a next loop iteration of the fuzzing test loop; and
if no anomaly is recognized, performing the next loop iteration of the fuzzing test loop.

It is understood that the steps according to the present invention as well as other optional steps do not necessarily have to be carried out in the order shown, but can also be carried out in a different order. Other intermediate steps can also be provided. The individual steps can also comprise one or more sub-steps without departing from the scope of the method according to the present invention.

According to a second aspect of the present invention, an apparatus for testing device software of a device DUT (device under test) by means of a fuzzing algorithm is provided. According to an example embodiment of the present invention, the apparatus comprises an evaluation and computing unit which is designed to execute the following steps:
initializing the fuzzing algorithm to detect an initial behavior of the device software of the device under test,
executing a fuzzing test loop, in particular until a termination criterion is reached, wherein the fuzzing test loop comprises the steps of:
generating a fuzzed message from predefined message types;
sending the generated, fuzzed message to the device under test to test the device software on the basis of the fuzzed message;
detecting side-channel information during testing of the device software on the basis of the fuzzed message;
recognizing anomalies in the detected side-channel information by means of at least one machine learning model and/or statistical algorithm; and
if an anomaly is recognized, adjusting a parameter, in particular adjusting fuzzability weights or fuzzability scores, of the initialized fuzzing algorithm and performing a next loop iteration of the fuzzing test loop; and
if no anomaly is recognized, performing the next loop iteration of the fuzzing test loop.

The explanations given for the method of the present invention apply accordingly to the apparatus of the present invention. It is understood that linguistic modifications of features formulated for the method can be reformulated for the apparatus in accordance with standard linguistic practice, without such formulations having to be explicitly listed here.

This method utilizes side-channel information in order to control the fuzzing process and direct it to different branches of the code. This can improve the recognition of vulnerabilities, in particular in a case if no source code is available. The present method is preferably used in the field of Internet of Things (IoT) devices and/or automotive (control) devices for testing the respective device software. In other words, the main application of the present method can be considered that of improving fuzz testing of wireless and/or automotive protocols. The present method offers a more targeted approach to fuzz testing and ensures a comprehensive evaluation of potential vulnerabilities in IoT and/or automotive devices. The present method can also be used for black box tests, with which access to side-channel information is given. As soon as the algorithm or method detects an anomaly in the side-channel information, this is described in detail in the (test) log file.

The importance of fuzz testing extends across various fields of technology, with a particular focus being placed on the security of wireless and/or automotive protocols. These protocols, which play a role in the operation and/or safety of modern vehicles in particular, are preferably tested against a variety of potential vulnerabilities in order to minimize the risks of cyberattacks and/or system failures. For this purpose, the present improved fuzz testing is used to ensure the robustness and reliability of these protocols. This method is particularly preferred for developing and securing automotive and embedded systems. The present method can preferably be implemented and/or executed on gateways and/or on-board computers, which are responsible in particular for networking and controlling critical vehicle functions.

By integrating the improved fuzz testing presented here into the development and safety testing process for these components, safety standards can be significantly increased. This optimized approach to security testing not only helps to identify and eliminate potential vulnerabilities at an early stage, but also helps to increase confidence in the security of communication systems, in particular automotive systems. This method contributes to general vehicle safety and protection against cyber threats.

In the present case, according to an example embodiment of the present invention, a machine learning model and/or at least one statistical algorithm can be applied to at least one piece of side-channel information. The at least one piece of side-channel information provides valuable feedback for mutation-based protocol fuzzing tools. Recognized anomalies in the side-channel information or side-channel data are preferably interpreted as newly discovered code behavior of the device software. The newly discovered code behaviors are used in the fuzzing feedback or looping process in the same way as a traditional code coverage-based approach.

A fuzzing algorithm is preferably a program or methodology that aims to test software, systems or devices (devices under test, DUTs) by automatically generating and sending modified or randomly generated data (known as “fuzz”). The core of the algorithm lies in its ability to generate unexpected, erroneous or extreme input data in order to identify bugs, security vulnerabilities or other weaknesses in the software. The process typically begins with an initialization phase in which the normal behavior of the DUT is detected in order to create a baseline for the test results. The algorithm then uses various data manipulation strategies to generate a wide range of potentially error-inducing inputs.

According to an example embodiment of the present invention, the fuzzing test loop is preferably the heart of the fuzzing process, an iterative loop that is automatically run through in order to generate different data variations (fuzzed messages) and send them to the DUT. Modified messages are systematically generated within this loop, which can potentially provoke faulty states in the DUT. Each run-through of the loop preferably involves generating a new fuzzed message which is based on predefined message types and fuzzability scores, sending this message to the DUT, and waiting for a response or observing the behavior of the DUT to determine if any unexpected or erroneous conditions have been triggered. This process is repeated in order to ensure comprehensive coverage of potential vulnerabilities.

In a further aspect of the present invention, it is provided that each message of the predefined message types has bit/byte fields, to each of which a fuzzability weight is assigned.

According to an example embodiment of the present invention, generating a fuzzed message from predefined message types is preferably a step in the fuzzing process. Each message is preferably constructed from bit or byte fields, wherein each field has a fuzzability score that indicates how likely it is that modifying this field will lead to an interesting test result. These fuzzed messages are then systematically generated by focusing on the fields with high fuzzability scores in order to maximize the efficiency of the test. After generation, the fuzzed message is sent to the DUT in order to test the response of the device to unexpected or non-standard inputs. This operation aims to identify vulnerabilities, errors or other anomalies in the device software that would possibly remain undetected under normal test conditions. By systematically sending these messages and analyzing the responses of the DUT, developers and testers can gain deep insights into the security and stability of the device software.

Various machine learning algorithms and/or statistical algorithms are preferably applied to the indicated side-channel information. The resulting findings guide the further fuzzing process. Control is preferably achieved by changing the fuzzability score of each bit/byte field. The corresponding fuzzability score is increased if an anomaly is detected in the side-channel information during fuzzing.

In a further aspect of the present invention, it is provided that initializing the fuzzing algorithm comprises: initializing in particular equal fuzzability weights; providing a pool of predefined message types; and generating a template for generating fuzzed messages from the provided pool of predefined message types.

Further initialization steps and/or further intermediate steps are also possible.

In a further aspect of the present invention, it is provided that detecting the side-channel information comprises loading the side-channel information into a FIFO database, in particular until the FIFO database is full or another termination criterion is reached.

In other words, the fuzzed message is sent and the side-channel information is detected and preferably loaded into a FIFO database. As soon as the database is full or another termination criterion is reached, recognizing anomalies in the at least one piece of side-channel information preferably begins.

The feature “loading side-channel information into a FIFO database” refers to the process by which data obtained through side-channel attacks is systematically inserted into a first-in-first-out (FIFO) database. A FIFO database is preferably a type of data structure or data storage system that manages entries in the order in which they are received. This means that the first element added to the database is also the first to be removed or processed. This principle is often used in the processing of data streams or in situations where the order of processing is crucial.

Loading side-channel information into such a FIFO database enables structured and time-ordered storage and processing of this data. This is particularly useful in security research and security systems analysis, since it allows researchers to analyze the collected data in the order it was collected, as a result of which patterns or anomalies can be identified more efficiently. It also enables automated processing and analysis of large amounts of side-channel information, which can be crucial for developing countermeasures or improving system integrity and security.

In a further aspect of the present invention, it is provided that adjusting the parameter comprises recording the recognized anomaly in a log file.

Once the machine learning algorithm and/or a statistical algorithm has detected an anomaly in the side-channel information, the recognized anomaly is described in a log file, which can be useful for a software developer in charge of the device to understand a specific problem and/or misbehavior of the device software.

In a further aspect of the present invention, it is provided that the side-channel information comprises an electromagnetic emission of the device and/or a power consumption of the device or other output data of the device, in particular during execution of the device software on the basis of each fuzzed message.

The side-channel information, for example electromagnetic emissions or power consumption of the device, is collected by the device during fuzzing, for example by sensors. A special case of side-channel information is output data from the device, which are normally ignored during fuzzing but can also be used as side-channel information in this case. In general, side-channel information is preferably data that does not come directly from the primary communication path, but from the analysis of indirect effects such as timing information, energy consumption, electromagnetic leakage or sound obtained during the execution of fuzzing.

In a further aspect of the present invention, it is provided that recognizing anomalies after the parameter is adjusted comprises checking a health state of the device and/or the device software, in particular by comparison with a moving average, wherein, if the health state falls below a predetermined limit value, an error report is generated, and the parameter is adjusted again.

After adjusting the parameter, an analysis is performed to recognize deviations or anomalies in the behavior of the device or the software. This step is preferred in order to indicate possible error states or deviations from the expected performance at an early stage.

A further feature of this aspect of the present invention is the comparison of the current operating data with a moving average. The moving average serves as a benchmark or reference value that smooths out changes over time and thus provides a reliable basis for evaluating the current health status of the device or software.

If the checked health status falls below a predefined limit value, i.e. if the current data deviates significantly from the expected normal status, this is considered a critical event. In such cases, the system automatically generates an error report. This report can contain detailed information regarding the type of anomaly, the parameter concerned and possible causes.

The parameters are adjusted again on the basis of the findings from the error report and/or the analysis of the health status.

In summary, the approach according to the present invention provides an iterative mechanism for monitoring, diagnosis and adjustment that aims to ensure the reliability and performance of devices and their software through continuous checking and adjustment. By using benchmarking methods such as comparison with a moving average and a defined response to recognized anomalies, this method enables proactive maintenance and troubleshooting, which can improve the service life and efficiency of the system.

In a further aspect of the present invention, a computer program having program code is provided for executing at least parts of the present method in one of its aspects when the computer program is executed on a computer. In other words, a computer program (product) comprising instructions which, when the program is executed by a computer, cause the computer to execute the method/the steps of the method in one of its aspects.

In a further aspect of the present invention, a computer-readable medium having program code of a computer program is proposed for executing at least parts of the present method in one of its aspects when the computer program is executed on a computer. In other words, the present invention relates to a computer-readable (memory) medium comprising instructions which, when executed by a computer, cause the computer to execute the method/the steps of the method in one of its aspects.

The described embodiments and developments of the present invention can be combined with one another as desired.

Further possible embodiments, developments and implementations of the present invention also include combinations not explicitly mentioned of features of the present invention described above or in the following relating to the exemplary embodiments.

### BRIEF DESCRIPTION OF THE DRAWINGS

The figures are intended to impart further understanding of the embodiments of the present invention. They illustrate embodiments and, in connection with the description, serve to explain principles and concepts of the present invention.

Other embodiments and many of the mentioned advantages are apparent from the figures. The illustrated elements of the figures are not necessarily shown to scale relative to one another.

FIG. 1 shows a schematic flow chart of an exemplary embodiment of the method of the present invention.

FIG. 2 shows a further schematic flow diagram of an exemplary embodiment of the method of the present invention.

### DETAILED DESCRIPTION OF EXAMPLE EMBODIMENTS

In the figures, identical reference signs denote identical or functionally identical elements, parts or components, unless stated otherwise.

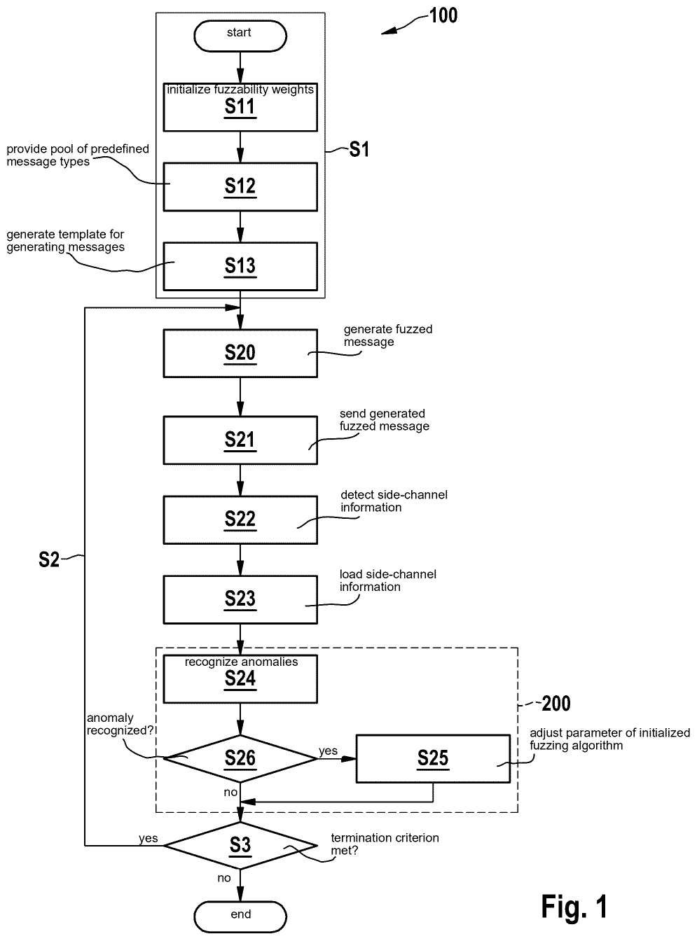

FIG. 1 shows a schematic flow chart of a method for testing the software of a device by means of a fuzzing algorithm.

In any embodiment, the method can be executed, at least in part, by an apparatus 100, which for this purpose can comprise a plurality of components not shown in more detail, for example one or more provision units and/or at least one evaluation and computing unit. It is self-evident that the provision unit can be designed together with the evaluation and computing unit, or can be different therefrom. Furthermore, the apparatus 100, which can be part of a system, can comprise a storage unit and/or an output unit and/or a display unit and/or an input unit.

The computer-implemented method comprises at least the following steps:

In a step S1, the fuzzing algorithm is initialized to detect the initial behavior of the device software of the device under test. This involves initializing S11 in particular equal fuzzability weights, providing S12 a pool of predefined message types, and generating S13 a template for generating fuzzed messages from the provided pool of predefined message types.

In a step S2, a fuzzing test loop is executed, in particular until a termination criterion is reached. Whether the termination criterion has been reached is preferably checked in a checking step S3 after each run-through of a loop. The termination criterion can, for example, be a maximum and/or predefined number of loop run-throughs, which is determined on the basis of a run-through time, for example.

The fuzzing loop is run through by executing the following steps:

In a step S20, a fuzzed message is generated from predefined message types. Each message of the predefined message types has bit/byte fields, to each of which a fuzzability weight is assigned.

In a step S21, the generated, fuzzed message is sent to the device under test to test the device software on the basis of the fuzzed message.

In a step S22, side-channel information is detected during testing of the device software on the basis of the fuzzed message.

Detecting S22 the side-channel information can preferably comprise loading S23 the side-channel information into a FIFO database, in particular until the FIFO database is full or another termination criterion is reached. The side-channel information comprises, for example, an electromagnetic emission of the device and/or a power consumption of the device or other output data of the device, in particular during execution of the device software on the basis of the respective fuzzed message.

In a step S24, anomalies in the detected side-channel information are recognized by means of at least one machine learning model.

In a step S25, a parameter of the initialized fuzzing algorithm is adjusted, in particular fuzzability weights are adjusted, and the next loop iteration of the fuzzing test loop is performed if an anomaly is recognized. Adjusting S25 the parameter preferably comprises recording the recognized anomaly in a log file.

In a step S26, the next loop iteration of the fuzzing test loop is performed immediately if no anomaly is recognized.

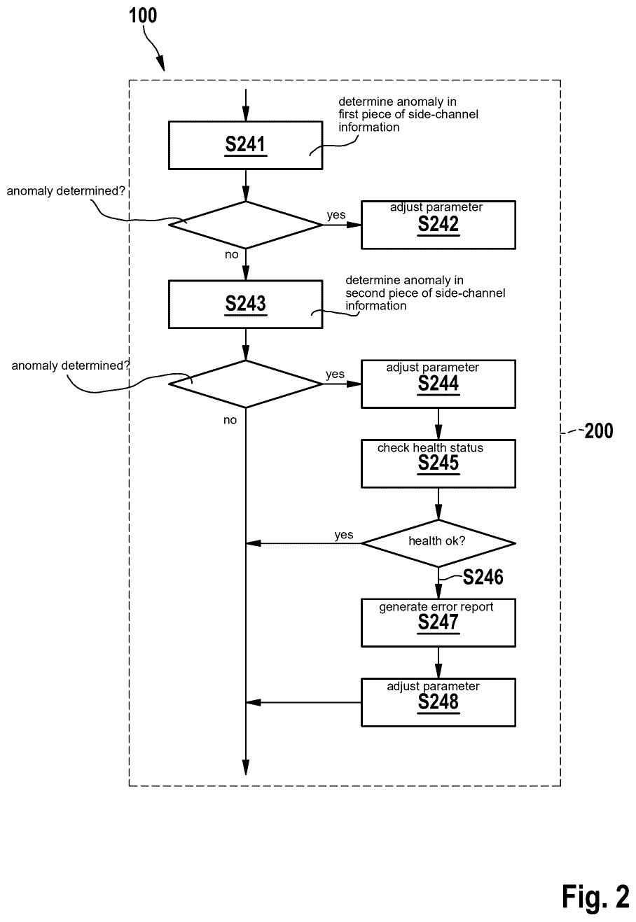

FIG. 2 shows a detailed view 200 of a section of the present method. Recognizing S24 anomalies can also be performed in a plurality of stages or for a plurality of pieces of side-channel information. For example, by means of the machine learning model, determining S241 (for example, DBSCAN) an anomaly in a first piece of side-channel information can be carried out. If an anomaly is recognized, the parameter is adjusted accordingly; see step S242. If no anomaly is recognized in the first piece of side-channel information, determining S243 (for example, by DBSCAN) an anomaly is carried out in a second piece of side-channel information, for example a power consumption of the device. If an anomaly is recognized in the second piece of side-channel information, the parameter is adjusted accordingly; see step S244. After adjusting 244 the parameter, checking S245 a health status of the device and/or the device software can also be carried out, in particular by comparison with a moving average. If the health status falls below a predetermined limit value (see S246), an error report is generated (see S247), and the parameter is adjusted S248 again.

1-10. (canceled)

11. A method for testing device software of a device using a fuzzing algorithm, the method comprising the following steps:
initializing the fuzzing algorithm to detect an initial behavior of the device software of the device under test; and
executing a fuzzing test loop until a termination criterion is reached, wherein the fuzzing test loop includes the following steps:
generating a fuzzed message from predefined message types,
sending the generated fuzzed message to the device under test to test the device software based on the fuzzed message,
detecting side-channel information during testing of the device software based on the fuzzed message,
recognizing anomalies in the detected side-channel information using at least one machine learning model and/or statistical algorithm,
based an anomaly being recognized, adjusting a parameter including fuzzability weights of the initialized fuzzing algorithm and performing a next loop iteration of the fuzzing test loop, and based on no anomaly being recognized, performing the next loop iteration of the fuzzing test loop.

12. The method according to claim 11, wherein each message of the predefined message types includes bit/byte fields, to each of which a fuzzability weight is assigned.

13. The method according to claim 11, wherein the initialization of the fuzzing algorithm includes:
initializing with equal fuzzability weights;
providing a pool of predefined message types; and
generating a template for generating fuzzed messages from the provided pool of predefined message types.

14. The method according to claim 11, wherein the detecting of the side-channel information includes loading the side-channel information into a FIFO database until the FIFO database is full or another termination criterion is reached.

15. The method according to claim 11, wherein the adjusting of the the parameter includes recording the recognized anomaly in a log file.

16. The method according to claim 11, wherein the side-channel information includes electromagnetic emissions of the device and/or a power consumption of the device and/or other output data of the device, during execution of the device software based on each fuzzed message.

17. The method according to claim 11, wherein the recognizing of the anomalies after the parameter is adjusted includes checking a health state of the device and/or the device software, by comparison with a moving average, wherein, when the health state falls below a predetermined limit value, an error report is generated, and the parameter is adjusted again.

18. A non-transitory computer-readable data carrier on which is stored program code of a computer program for testing device software of a device using a fuzzing algorithm, the computer program, when executed by a computer, causing the computer to perform the following steps:
initializing the fuzzing algorithm to detect an initial behavior of the device software of the device under test; and
executing a fuzzing test loop until a termination criterion is reached, wherein the fuzzing test loop includes the following steps:
generating a fuzzed message from predefined message types,
sending the generated fuzzed message to the device under test to test the device software based on the fuzzed message,
detecting side-channel information during testing of the device software based on the fuzzed message,
recognizing anomalies in the detected side-channel information using at least one machine learning model and/or statistical algorithm,
based an anomaly being recognized, adjusting a parameter including fuzzability weights of the initialized fuzzing algorithm and performing a next loop iteration of the fuzzing test loop, and based on no anomaly being recognized, performing the next loop iteration of the fuzzing test loop.

19. An apparatus configured to test device software of a device using a fuzzing algorithm, wherein the apparatus comprises an evaluation and computing unit which is configured to execute the following steps:
initializing the fuzzing algorithm to detect an initial behavior of the device software of the device under test; and
executing a fuzzing test loop until a termination criterion is reached, wherein the fuzzing test loop includes the steps of:
generating a fuzzed message from predefined message types,
sending the generated, fuzzed message to the device under test to test the device software based on the fuzzed message,
detecting side-channel information during testing of the device software based on the fuzzed message,
recognizing anomalies in the detected side-channel information by means of at least one machine learning model and/or statistical algorithm, and
based on an anomaly being recognized, adjusting a parameter including fuzzability weights of the initialized fuzzing algorithm and performing a next loop iteration of the fuzzing test loop, and based on no anomaly being recognized, performing the next loop iteration of the fuzzing test loop.
